(19) United States
(12) Patent Application Publication
(10) Pub. No.: US 2013/0267262 A1
(43) Pub. Date: Oct. 10, 2013

(54) SYSTEM AND METHOD FOR DECODING AND/OR ENCODING A TEXT MESSAGE OR INSTANT MESSAGE SENT BY A WIRELESS DEVICE AND TRANSMITTING AUDIO AND/OR VIDEO CONTENT TO THE RECIPIENT OF THE TEXT MESSAGE OR INSTANT MESSAGE BASED ON KEY WORDS IN THE TEXT MESSAGE

(71) Applicant: Mark Anthony DeMattei, Greensboro, GA (US)

(72) Inventor: Mark Anthony DeMattei, Greensboro, GA (US)

(73) Assignee: TEXTBEATS, LLC, Greensboro, GA (US)

(21) Appl. No.: 13/857,248

(22) Filed: Apr. 5, 2013

Related U.S. Application Data
(60) Provisional application No. 61/620,521, filed on Apr. 5, 2012.

(51) Int. Cl. H04W 4/12

(52) U.S. Cl. CPC H04W 4/12
USPC 455/466

(57) ABSTRACT

A text messaging computer-implemented system is disclosed for providing embedded multi-element (text message and the inclusion of any audio recorded or video recorded) content by authenticating a mobile device compatible with multiple transport technologies (such as 4G and 5G networks) and operable to render a text message with an integrated audio and/or video embedded message within a text message originating from a first mobile device. The system may include a mobile device such as a cell phone mounted on a garment.

### CROSS-REFERENCE To RELATED APPLICATIONS

This application claims the benefit of and priority to U.S. Provisional Application Ser. No. 61/620,521 filed Apr. 5, 2012, the contents of which are incorporated by reference herein in its entirety.

### BACKGROUND

The invention relates to text messaging over mobile devices; and, more particularly, to a system and method for decoding such messages to determine key words therein and select video and/or audio content relating to the key words and transmitting the selected content to the recipient of the text message.

### RELATED ART

Text messaging over mobile devices, such as cell phones, is well known. Generally, the sender types a message into the device and sends it to the intended recipient.

### SUMMARY OF THE INVENTION

It is an object of this invention to provide a system and method of decoding text messages, consider the content thereof relating to preselected key words in the message, and transmit audio and/or video content relating to the pre-selected key words to the intended recipient of the text message.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 is an illustration of a trading of messages where the answer by the recipient generates creation of a menu of audio and/or video content relating to the answer by the recipient;

FIG. 2 is an illustration of one of the menu selections of FIG. 1 which can be attached and sent to the recipient;

FIG. 3 is an illustration of an alternate menu selection which can be attached and sent to the recipient;

Fig, 4 is an illustration of the recipient's receipt of the menu selection of FIG. 2 enabling the recipient to play the audio and/or video clip;

FIG. 5 is an illustration of the recipient's receipt of the menu selection of FIG. 3 enabling the recipient to play the audio and/or video clip;

FIG. 6 is an illustration of the recipient's choices for either keeping the clip of FIG. 4 or purchasing the complete movie relating to the clip;

FIG. 7 is an illustration similar to FIG. 6 where the recipient has the choice of keeping the alternate audio and/or video clip of FIG. 5 or purchasing the complete song relating to the audio and/or video clip,

FIG. 8 is a frontal view of a garment that may be used in conjunction with the invention; and

FIG. 9 is a rear view of the garment of FIG. 8.

### DESCRIPTION OF THE PREFERRED EMBODIMENT

The invention contemplates a computer implemented system that can accept a request from a first mobile device for a text message or instant message that is accompanied with an embedded audio and/or video recording associated with at least one word or a plurality of words that are included in the text message or instant message. A text messaging or instant messaging user interface is preprogrammed to select recordings from a group of candidate recordings associated with a specified word or plurality of words of the text message or instant message from an appropriate list of audio and/or video recordings stored on a remote server, the internet, the cloud, in memory within the wireless device or in any storage location containing a plurality of audio recordings and/or video recordings that may be accessible by a wireless device. These audio and/or video recordings are retrieved based on a key word or key words input within the body of the text message originating from the first mobile terminal user's text messaging interface.

If the second or group of mobile device users have the system installed on their wireless device, they may also respond back to the first user's wireless device using the same interface.

The key word or key words that are input in the body of the text message through a first mobile user's interface will access a database that will provide a select list of audio and/or video recordings based on the first mobile device user's text message content typed in by the first mobile device user (and second or group of users if the system is installed on their wireless device) and includes a list of audio and video recordings. The method and system herein attaches and embed the selected audio and/or video recording to the text message from the first mobile device user and sends it to a receiving (second) mobile device. The audio or video file may be attached as a link to the audio or video that is streamed from the server to the wireless device from the recording device or group of devices.

The database contains a library of audio and video recordings that are categorized by key words that directly relate to the title of an audio or video recording or key words from within the body of work within the audio or video recording, each of which are associated with titles, lyrics or exact text associations to key words contained within an audio or video recording, such as “touch”, “leave”, “care”, “kiss”, and such. For example; a first mobile device user types a text message saying. “I want to kiss you”. The user's mobile device accesses the requesting source MTSD database or may access audio or video files stored in memory within the device such as iTunes (may access a plurality of data sources simultaneously or other downloaded or cloud connected content libraries as known in the art) and a list of audio recordings or video recordings appear in the mobile device display with the following options:

“I Want To Kiss You” by Devin

“I Want to Kiss You” by Laurelyn Carter

“I Want to Kiss You” by Edward O'Connell

(I Want To) Kiss You All Over” by Dirt Merchants

“Kiss You All Over” by Exile

A first mobile device user selects a preferred recording title from the requesting MTSD source and it facilitates the selection and embeds or creates a link to be able to stream the recording into the specified message to be sent to the receiving device (second mobile device or group of devices) in cooperation with the audio and/or video recording.

In some of the embodiments, the order of the audio or video recording content may be derived from random selection or a designated order, on a pay-for-position or some other designation format.

In some of these embodiments, the message includes text, an audio recording and/or a video recording. And in other embodiments, the software is able to cause the computer to provide a user interface that can facilitate specific requirements of the message.

In various preferred embodiments, the invention further includes media containing the database containing a plurality of audio and video recordings associated with selectable exact key word or key words categories.

Another general aspect of the present invention is to utilize the MTSD System to send a transmission of a text message that includes embedded audio or video content from a cloud-based computer-implemented system to a first mobile device, second mobile device or a group of mobile devices having a context identification number.

In preferred embodiments, utilization of the MTSD System to send a wireless transmission in response to a text message that is received and includes embedded or links that may include streaming audio or video content direct to a first, second or a group of wireless mobile devices communicating with a (MTSD) database containing answers to a plurality of questions asked by a text message or instant message user that is catalogued by specific categories or individuals such as Presidents, Dignitaries, Professional Athletes, Celebrities, Characters or other persons, whether animated, living or deceased, all based on key words.

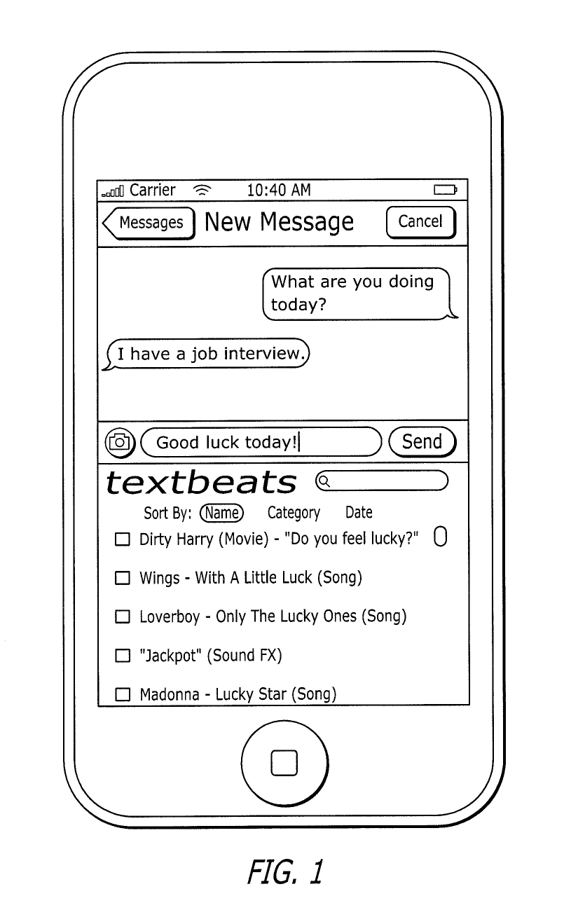

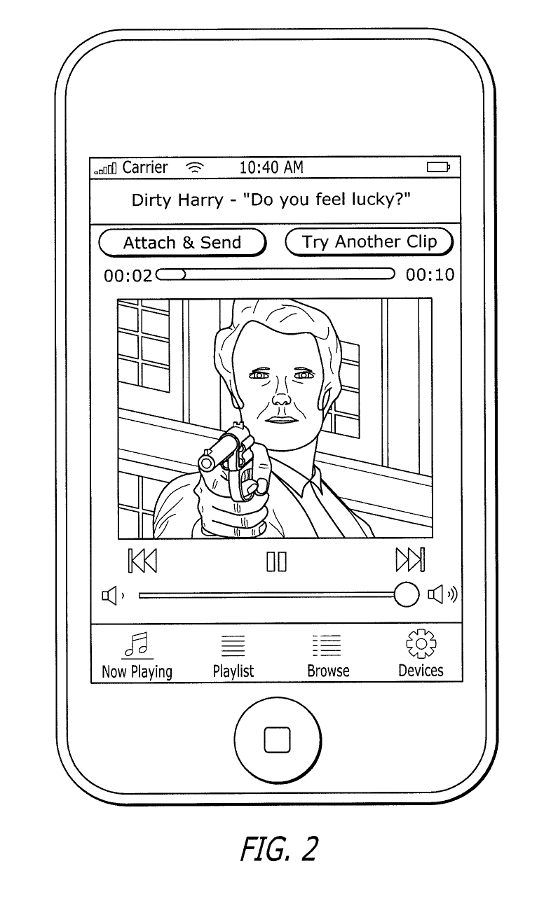

Reference is made to FIGS. 1 to 7 as an example of how to carry out the teachings of the invention, FIG. 1 shows the face of a mobile phone with an inquiry made by the first user of a phone (“What Are You Doing Today?”) to a recipient, User of the other phone (recipient) answers: “I have a job interview,” (shows up on first phone—FIG. 1). The sender decides to answer “Good luck today!” Based on this input, the system searches the database and selects 5 audios and/or videos relating to the concept of “Lucky”. The user of the first phone selects one of the 5 listed in the menu. The selected audio/video shows up on the sender's phone (FIG. 2) where the sender has various options as shown. One of the options is to attach and send the selection; another is to Try Another Clip.

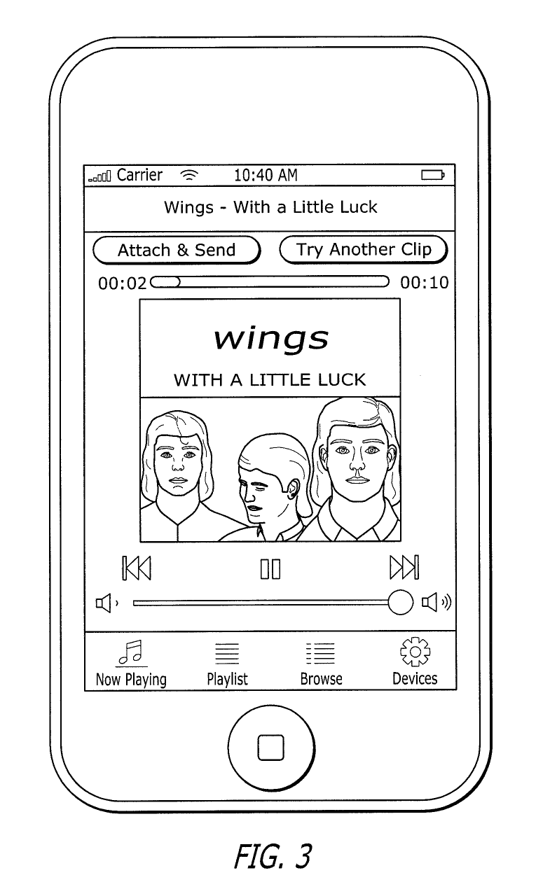

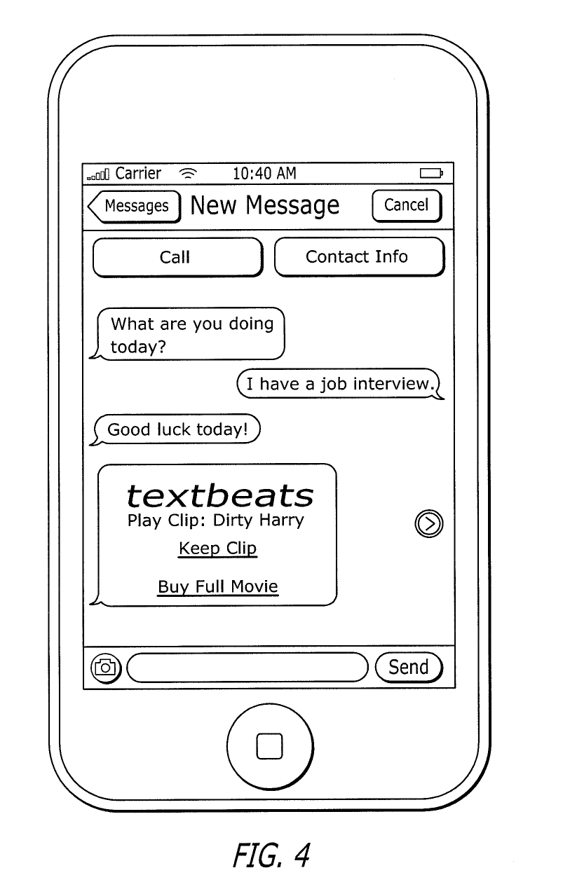

In this case, the sender selects the alternate audio/video clip shown in FIG. 3 (not shown is what happens when “Try Another Clip” is selected in FIG. 2—the menu of Fig, 1 is re-displayed allowing the alternate selection).

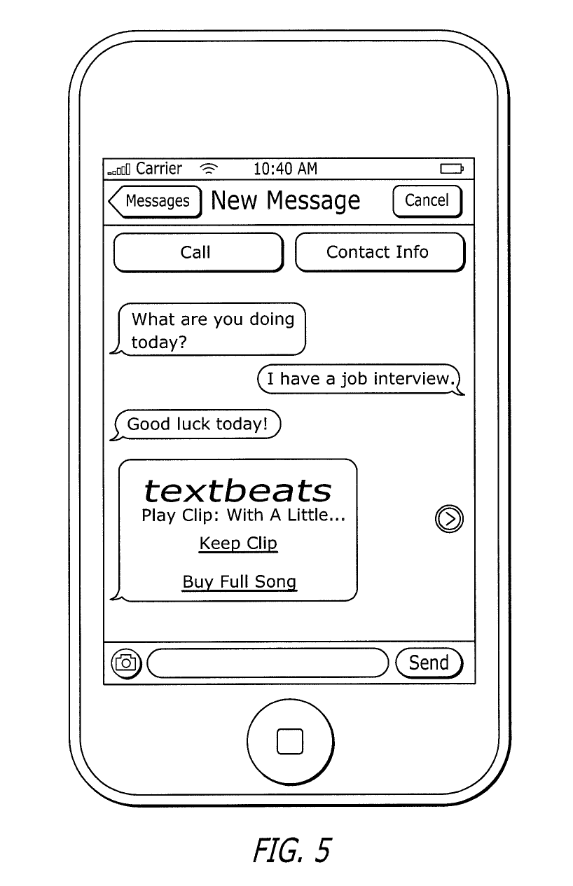

FIG. 4 shows the face of the recipient's cell phone where he or she sees the message “Good Luck Today!” and can play the selected audio/video clip of FIG. 2. FIG. 5 is similar to FIG. 4 and displays the alternate selection.

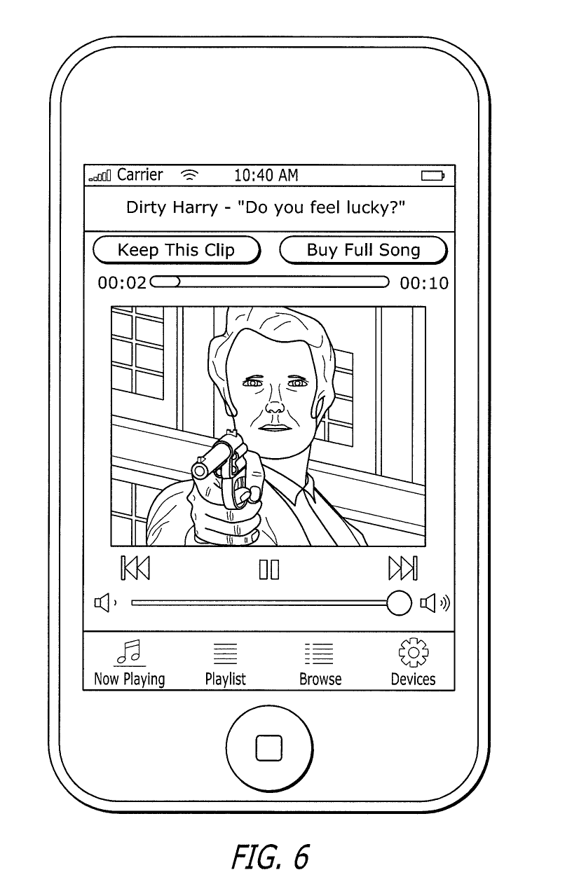

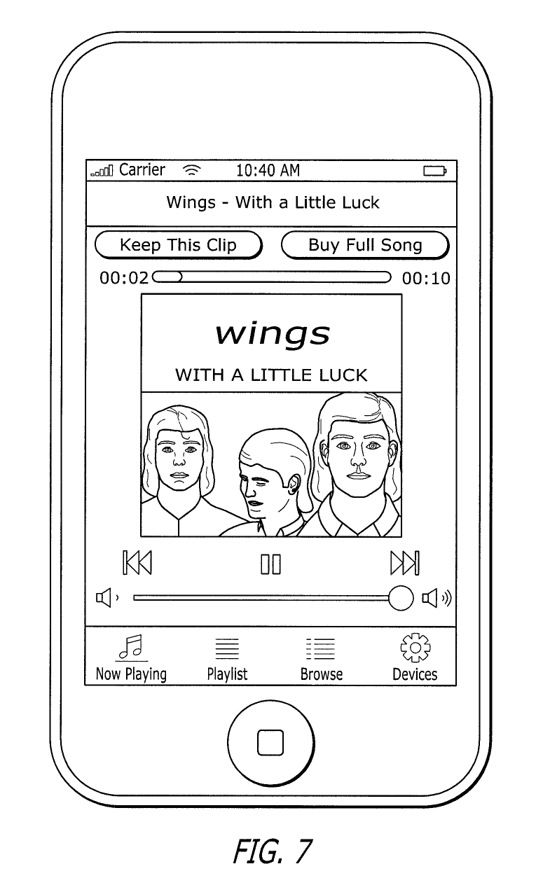

In FIG. 6, the recipient has the option to keep the clip shown in FIG. 4 or buy the full movie from which it came. FIG. 7 is similar to FIG. 6 showing the alternate selection where the recipient can keep the clip or buy the full song.

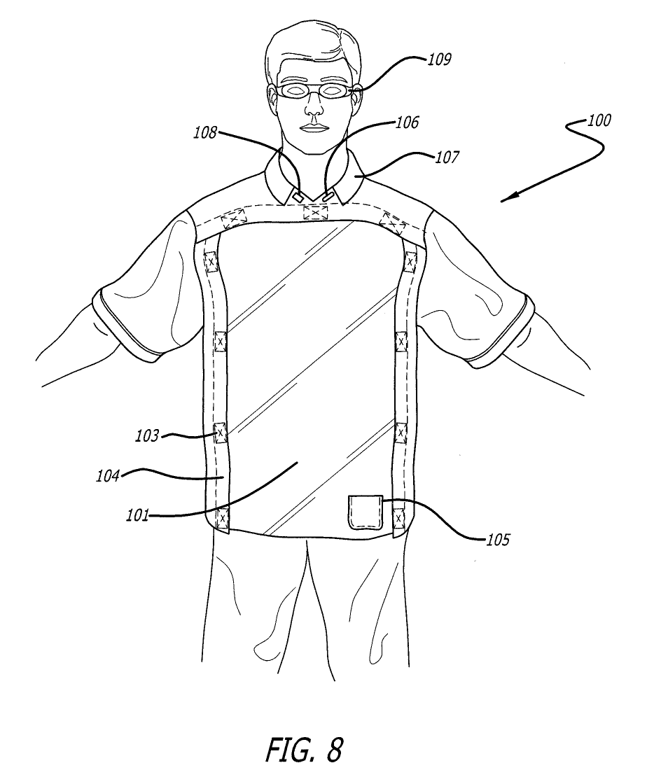

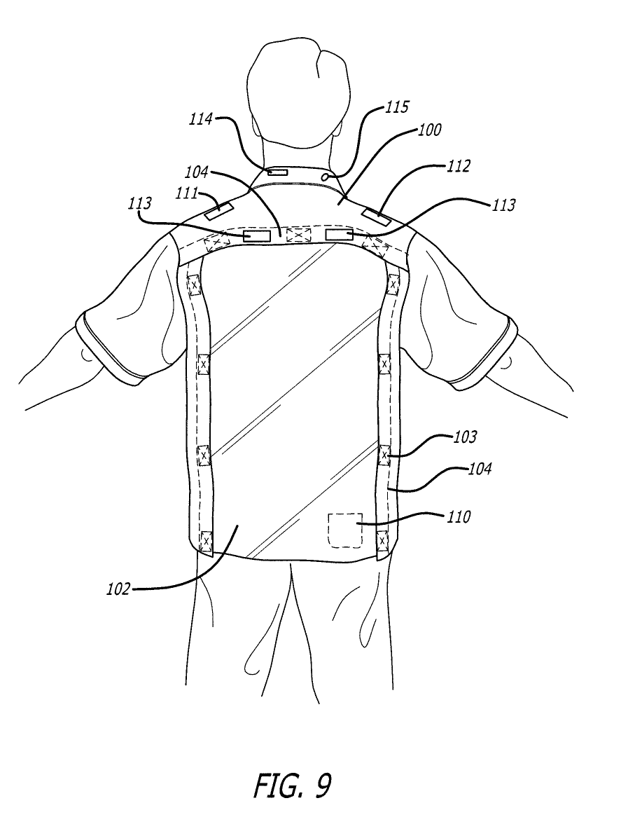

As seen in FIGS. 8 and 9, a garment 100 is shown which may be similar to the garment in U.S. Pat. No. 7,571,495, which shows a removable billboard panel, such as panel 101 on the front, and panel 102 on the rear. These panels 101, 102 may be removable from garment 100, as disclosed in U.S. Pat. No. 7,571,495, and held in place by the patches 21 and border 17 in U.S. Pat. No. 7,571,495 (patches 103 and border 104 herein).

The panels 101, 102 in this application have added features. Thus, in FIG. 8, there is a pocket 105 for a wireless mobile device (not shown) seen on the front panel 101. A built in microphone 106 may be provided at top adjacent collar 107 wirelessly coupled to said wireless device. An earpiece plug-in jack and wireless transmitter 108 wirelessly coupled to all components may be provided on the opposite side of the garment 100 adjacent collar 107. Certain hardware for operating the cell phone or other mobile device may be provided in wearable eyewear 109.

The operation of the mobile device is discussed above with references to FIGS. 1 to 7.

In FIG. 9, there is a battery pack with a rechargeable system 110 seen in a pocket (outside stitching only visible in FIG. 9) on the inside of panel 102 for providing a charge to the wireless device. One or more charger connectors 111, 112 may be provided on garment 100 at top on opposite sides. A scent or odor disseminator 113 may be provided on the top border 104. A data communication transmitter/receiver 114 may be provided on the back of collar 107 on one side thereof with a GPS location tracker 115 on the opposite side of the back of collar 107. All components may be wirelessly connected as is well known in the art.

“Clip” as used herein can be an audio clip, a video clip, or a combination of audio and video.

Thus, there is disclosed a text messaging computer-implemented system and method for providing embedded multi-element (text message and the inclusion of any audio recorded or video recorded) content by authenticating a wireless device compatible with multiple transport technologies (such as cellular networks, satellite networks, cloud based networks, internet networks, Bluetooth networks, near field communication networks or other peer to peer networks as used in the art) and operable to render a text message with an integrated audio or video embedded message or a link that connects to a streaming audio or video file within a text message originating from a first mobile device, second mobile user, a group of mobile users, Instant Messaging, SMS (Short Message Service) or MMS (Multimedia Message Service), in a manner consistent with the capabilities of the recipient device (second mobile device). The system and method includes: transmission of a text message that includes embedded audio and/or video content having a context identification number from a first mobile device to a second mobile device. This may include a mobile station (MS) receiving a wireless message. A judgment may be made whether the received message is a general SMS message or a SMS message for a MMS. The message may be directly stored if the received message is a general SMS message. The recipient may then be informed of a message reception.

In various preferred embodiments, the first authenticating is provided at a mobile device compatible with multiple transport technologies (such as 4G and 5G networks) and operable to render an integrated audio or video embedded message within a text message originating from a first mobile device. A second mobile device is enabled to respond to the first device message and an instant response will be provided based on the content of the message sent.

Although the terms text messages and instant messages have been used, the system and method disclosed herein can be used to decode and/or encode and transmit any suitable communication by any suitable media.

Although a particular embodiment of the invention is disclosed, variations thereof may occur to an artisan and the scope of the invention should only be limited by the scope of the appended claims.

1. A method for decoding and/or encoding text messages, SMS messages, MMS messages or instant messages transferred between at least a pair of wireless devices, and transmitting audio or video content relating to said decoding and/or encoding comprising the steps of:
setting up a database of audio and video recordings and related media content at a remote location, wirelessly connected to said pair of wireless devices;
setting up an algorithm of key words and connecting the same to said media content at said remote location;
decoding any messages sent to one of said wireless devices by the other of said wireless devices utilizing said algorithm to select media content at said remote location relating to the key words in said decoded messages and transmitting said selected media content to one of the said wireless devices;
providing a garment having a front and back and a pocket; and
storing said wireless device in said pocket.

2. The method of claim 1, including the steps of:
providing a display panel on said garment;
providing a built-in microphone wirelessly connected to said wireless device in said garment;
providing an earpiece plug-in, said jack being wirelessly connected to said wireless device in said garment; and
providing a wireless transmitter and a receiver wirelessly coupled to said wireless device in said garment.

3. The method of claim 2 including the steps of providing a rechargeable battery pack wirelessly coupled to said wireless device for charging said wireless device on said garment.

4. The method of claim 3 including the step of providing a GPS locator on said garment wirelessly connected to said wireless device.

5. The method of claim 4 including the step of providing a battery charger connected on said garment wirelessly connected to said wireless device.

6. The method of claim 5 including the step of providing a scent or odor disseminator on said garment wirelessly connected to said wireless device.

7. The method of claim 6 including the step of providing eyewear for a wearer of said garment, said eyewear being in wireless communication with said wireless device.

8. The method of claim 1 wherein the step of setting up said database includes the step of setting up said database in a cloud based system.

9. The method of claim 1 wherein the step of setting up said database includes the steps of setting up said database at an internet terminal.

10. The method of claim 1 including the stop of providing selection means at said one of said wireless devices associated with said selected media content to select media associated with said selected media content.

11. A system for decoding and/or encoding text messages and transmitting audio or video content relating to said decoding and/or encoding comprising:
a database containing pre-selected audio and video recordings and related media content;
an algorithm of key words connected to said database;
a wireless device at a location remote from said database for decoding and/or encoding a text message sent by another wireless device to determine if one or more key words of said algorithm appear in said text message, and said wireless device having content selection means associated therewith for selecting audio and/or video content from said database relating to said one or more key words; and
transmission means for transmitting said selected audio and/or video content to the wireless device of the intended recipient of said text message; and
a garment having a front and back and a pocket, said wireless device being disposed in said pocket,

12. The system of claim 11 wherein said garment includes a billboard display panel removably attached thereto, said display panel on said panel, a built-in microphone in said garment wirelessly connected to said wireless device.

13. The system of claim 12 including an earpiece plug-in mounted on said garment wirelessly connected to said wireless device.

14. The system of claim 13 including a wireless transmitter and receiver mounted on said garment wirelessly connected to said wireless device.

15. The system of claim 14 wherein said garment includes a rechargeable battery pack thereon wirelessly connected to said wireless device for charging said wireless device.

16. The system of claim 15 wherein said garment includes a GPS locator mounted thereon wirelessly connected to said wireless device.

17. The system of claim 16 wherein said garment has a battery charger connector mounted thereon wirelessly connected to said wireless device.

18. The system of claim 17 wherein said garment has a scent or odor disseminator mounted thereon wirelessly connected to said wireless device.

19. The system of claim 18 wherein eyewear is provided for wearing thereof by a wearer of said garment, said eyewear being in wireless communication with said wireless device.

20. The system of claim 11 wherein said database is at a cloud-based location.

21. The system of claim 11 wherein said database is at an internet based terminal.
